(19) United States
(12) Patent Application Publication
(10) Pub. No.: US 2010/0032619 A1
(43) Pub. Date: Feb. 11, 2010

(54) Method for producing a particle-containing functional layer and functional element comprising such a layer

(76) Inventors: Rene Jabado, Berlin (DE); Jens Dahl Jensen, Berlin (DE); Ursus Krüger, Berlin (DE); Daniel Körtvelyessy, Berlin (DE); Volkmar Lüthen, Berlin (DE); Ralph Reiche, Berlin (DE); Michael Rindler, Schoneiche (DE); Raymond Ullrich, Schonwalde (DE)

Correspondence Address: King & Spalding LLP, 401 Congress Avenue, Suite 3200, Austin, TX, 78701, US

(21) Appl. No.: 12/440,898

(22) PCT Filed: Sep. 14, 2006
(86) PCT No.: PCT/DE06/01640

§ 371 Date: Oct. 5, 2009

(51) Int. Cl. C09K 3/00

(52) U.S. Cl. 252/182.32; 252/182.33

(57) ABSTRACT

In a method for producing a particle (10) containing functional layer (310, 400, 600), nanoparticles are introduced into the functional layer material (320, 410, 610), the nanoparticles having a particle core (20) and a particle shell (30) surrounding the particle core. The material (K) of the particle core has a higher chemical activity than that of the particle shell and the material (M) of the particle shell allows diffusion of the material of the particle core through the particle shell into the functional layer material.

The invention relates to a method having the features according to the preamble of claim 1. The term “functional layer” is to be understood in this context as meaning a layer which has a technical function, for example exhibits a catalytic action or exerts a protective action for an article coated with the functional layer.

A method of this type is known from European laid-open publication EP 1 548 134. In this method, a functional layer is formed from a metal matrix material into which nanoparticles are embedded. The fraction of nanoparticles amounts to between 4 and 30%. The layer composed in this way may be used, for example, for turbines.

The object on which the invention is based is to specify a method for forming a functional layer, the properties of which can be set with high accuracy.

This object is achieved according to the invention, by means of a method having the features according to patent claim 1. Advantageous refinements of the method according to the invention are specified in subclaims.

Thus, according to the invention, there is provision for there to be introduced into the functional layer material particles, which have a particle core and a particle shell surrounding the particle core, the material of the particle core being chemically more active than that of the particle shell, and the material of the particle shell making it possible for the material of the particle core to diffuse out through the particle shell into the functional layer material.

A substantial advantage of the method according to the invention is that, due to the less active shell of the particles, a time control of the action of the particles can take place in a very simple way. It was found by the inventors that particles consisting of an active material are sometimes consumed very quickly because, for example, they react with oxygen, so that their action is not very long. Owing to the consumption of the particles, the functional layers, the properties of which are mostly influenced decisively by the particles, will likewise vary, as a rule be impaired, so that the achievable useful life of the functional layer is limited. This is where the invention comes in, in that the particles are provided with a particle shell or particle casing which is less active than the particle core. The particles (atoms or molecules) of the particle core therefore first have to diffuse through the casing before they can exert their action within the functional layer. Thus, by a suitable choice of the casing material or shell material and/or the shell thickness, the interaction of the active particle core with the functional layer can be controlled, and therefore the useful life of the functional layer can be increased.

According to an advantageous refinement of the method, there is provision for nanoparticles to be introduced as particles into the functional layer material. Nanoparticles are particles which have a particle size in the nanometer range (1 nm to 1000 nm) and which mostly exhibit physical and chemical properties which differ from those of their particle material as such. The different properties of the nanoparticles are based on the relatively large outer surface in relation to their volume.

Preferably, the active particle core consists of a more base material or of a less inert material than the particle shell. For example, the particle core may consist of a material which is highly reactive with oxygen and which binds free oxygen atoms chemically within the functional layer; in this way, the concentration of oxygen in the functional layer can be reduced and a corrosion of the material of the functional layer can be prevented, at least reduced. The core material thus acts as sacrificial material which reduces the concentration of oxygen.

Particularly preferably, the material of the particle core is more base or less inert than the material of the functional layer. What is achieved with this refinement of the method is that, for example, oxygen atoms within the functional layer are trapped by the diffused-out free particles of the particle core, so that the functional layer does not corrode, at least less than otherwise.

The property of a material, in particular of a metal, to be noble or base arises from the respective redox potential or the electrochemical series; the following list, intended to be illustrative, not conclusive, of metals suitable for nanoparticles is classified from base toward noble or in terms of rising redox potentials:

| | |
|---|---|
| Lithium | −3 V |
| Magnesium | −2.4 V |
| Aluminum | −1.7 V |
| Zinc | −0.8 V |
| Silver | +0.8 V |
| Palladium | +0.9 V |

In order to avoid the situation where the particle shell is consumed, for example, due to corrosion and therefore loses its property as a “diffusion brake”, it is considered advantageous if the material of the particle shell is at least as noble as the material of the functional layer, preferably more noble than this. Oxygen bonds will therefore take place first with the material of the particle core and subsequently with the functional layer as soon as the particle cores are used up; by contrast, the particle shell of the nanoparticles is maintained.

Suitable particularly as a corrosion brake are nanoparticles, the core material of which consists of aluminum, magnesium, iron, zinc or a mixture of these materials; the use of these materials is therefore considered to be advantageous.

For example, nanoparticles are used, the shell material of which consists of a nobler metal or metal mixture than the core material; the core material then clearly forms a kind of sacrificial anode. Alternatively, nanoparticles may be used, the shell material of which consists of a metal oxide, in particular aluminum oxide. It is also conceivable to use nanoparticles, the shell material of which consists of a glass (for example, spin-on glass) or enamel.

In the choice of material, preferably, a material combination is selected in which the core material and the shell material have identical or at least similar coefficients of thermal expansion (a deviation of preferably less than 10%), in order to prevent the casing or shell from flaking off or splitting open during heating.

In order to prevent flaking off or splitting open, an amorphous shell material (for example, amorphous Al₂O₃) may also be selected, because amorphous materials, as a rule, are mechanically more flexible and can therefore adapt easily to a change in the core size of the particle.

In terms of the production of temperature-resistant protective layers, it is considered advantageous if the functional layer material contains MCrAlY material (metal matrix material based on chromium, aluminum and yttrium) or is formed by it.

For example, the functional layer is applied to a functional element, such as a turbine part, in particular a turbine blade.

With a view to a particularly high temperature resistance of the functional element, it is considered advantageous if the functional element is coated with MCrAlY material and nanoparticles as a functional layer, and if a thermal protection layer is applied to it. The thermal protection layer applied may be, for example, a TBC (thermal barrier coating) layer based on a columnar zirconium oxide ceramic layer.

Alternatively, a functional layer which has the functional element material and the nanoparticles or consists thereof may be applied to the functional element. Moreover, optionally, a further layer, which has MCrAlY material with or without additional nanoparticles having the core/shell set-up initially described, may be applied to such a functional layer.

A thermal protection layer (TBC layer) may also be applied to such a further layer or further functional layer in order to increase temperature resistance.

The invention relates, moreover, to a functional element comprising a particle-containing functional layer.

In order, in such a functional element, to achieve a particularly good settability of the properties of the functional layer and, in particular, a long useful life of the functional layer and consequently a long useful life of the functional element, there is provision, according to the invention, for the functional layer material to contain particles, in particular nanoparticles, which have a particle core and a particle shell surrounding the particle core, the material of the particle core being more active than that of the particle shell, and the material of the particle shell making it possible for particles of the particle core to diffuse out through the particle shell into the functional layer material.

The functional element may be, for example, a turbine element, in particular a turbine blade.

With regards to the advantages of the functional element according to the invention, reference may be made to the above statements relating to the method according to the invention, since the advantages of the method according to the invention and those of the functional element according to the invention largely correspond to one another in substance.

The invention relates, moreover, to nanoparticles for the production of functional layers.

In order, in such nanoparticles, to achieve a particularly good settability of the properties and, in particular, a long useful life, there is provision, according to the invention, for the nanoparticles to have a particle core and a particle shell surrounding the particle core, the material of the particle core being more active than that of the particle shell, and the material of the particle shell making it possible for particles of the particle core to diffuse out through the particle shell and out of the respective nanoparticle.

With regards to the advantages of the nanoparticles according to the invention, reference may be made to the above statements relating to the method according to the invention, since the advantages of the method according to the invention and those of the nanoparticles according to the invention largely correspond to one another in substance.

In terms of a use of the nanoparticles for a corrosion-inhibiting coating, it is considered advantageous if the particle core consists of a material more reactive with oxygen than that of the particle shell.

Preferably, the core material consists of aluminum, magnesium, iron, zinc or a mixture of these materials.

For example, the shell material consists of a nobler metal or metal mixture than the core material. Alternatively, the shell material may consist of a metal oxide, in particular aluminum oxide (Al₂O₃). The shell material may also be formed from a glass or from enamel.

The invention relates, moreover, to a method for the production of nanoparticles.

In order, in such a method, to achieve a particularly good settability of the properties and, in particular, a long useful life of the nanoparticles, there is provision, according to the invention, for a particle core to be formed and for this to be surrounded with a particle shell, a less active material being selected for the particle shell than for the particle core, which material makes it possible for the particles of the particle core to diffuse out through the particle shell and out of the respective nanoparticle.

With regards to the advantages of the method according to the invention for the production of nanoparticles, reference may be made to the above statements relating to the method according to the invention for producing a functional layer, since the advantages of the two methods correspond to one another in substance, because they are based on the same inventive idea.

The invention is explained in more detail below by means of exemplary embodiments; in the drawings, for example,

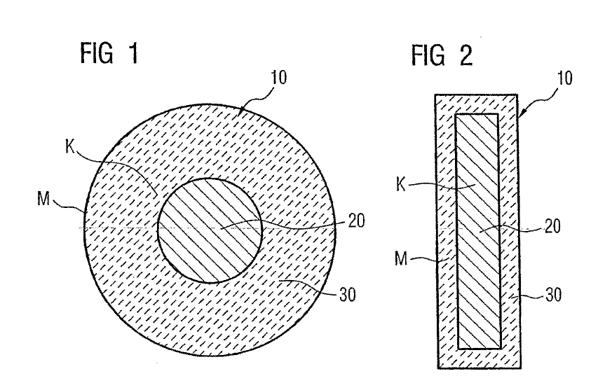

FIG. 1 shows an exemplary embodiment of a spherical nanoparticle with a core/casing structure,

FIG. 2 shows an exemplary embodiment of a columnar or rod-shaped nanoparticle with a core/casing structure,

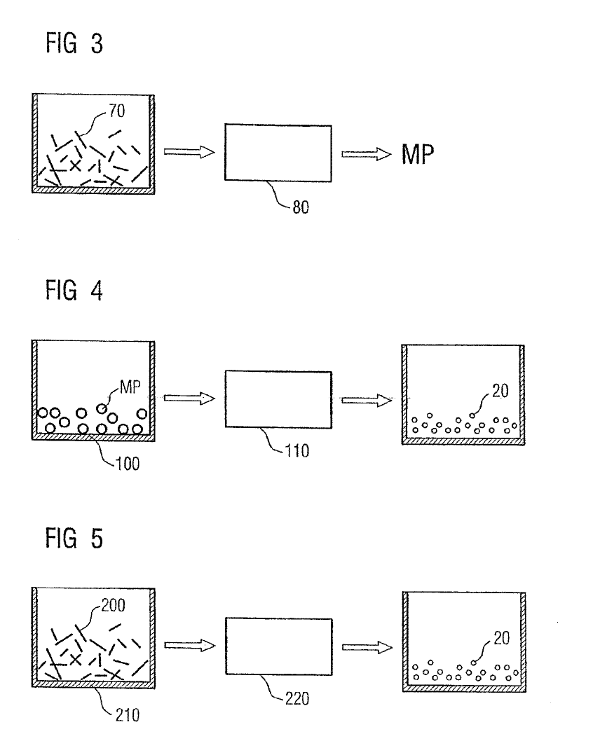

FIG. 3 shows an exemplary embodiment of an arrangement for the production of microparticles,

FIG. 4 shows an exemplary embodiment of an arrangement for the production of nanoparticles by means of the microparticles according to FIG. 3,

FIG. 5 shows a further exemplary embodiment of an arrangement for the production of nanoparticles,

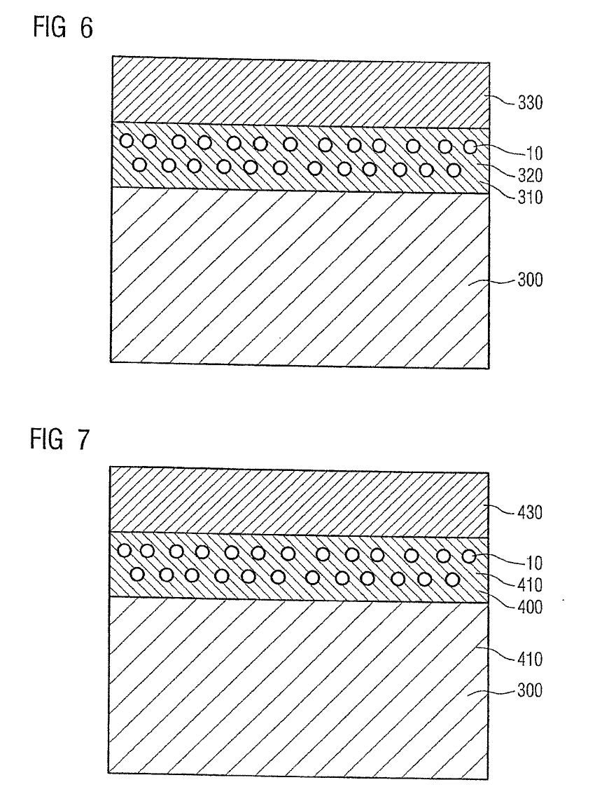

FIG. 6 shows by way of example a portion of a turbine blade, not illustrated in any more detail, with a functional layer based on MCrAlY material having nanoparticles with a core/casing structure,

FIG. 7 shows by way of example a portion of a turbine blade, not illustrated in any more detail, with a functional layer based on turbine blade material having nanoparticles with a core/casing structure,

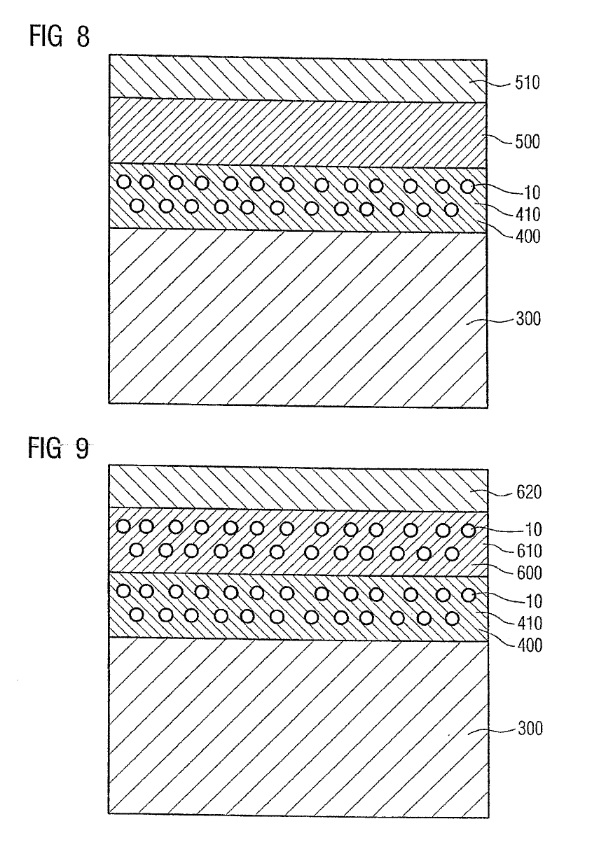

FIG. 8 shows by way of example a portion of a turbine blade, not illustrated in any more detail, with a functional layer based on turbine blade material having nanoparticles with a core/casing structure and also with a layer of MCrAlY material located on it, and

FIG. 9 shows by way of example a portion of a turbine blade, not illustrated in any more detail, with a functional layer based on turbine blade material having nanoparticles with a core/casing structure and also with a further functional layer located on it and consisting of MCrAlY material having nanoparticles with a core/casing structure.

In FIGS. 1 to 9, the same reference symbols are used for identical or comparable elements, insofar as this facilitates a clearer view.

FIG. 1 shows an exemplary embodiment of a nanoparticle 10. A particle core 20 can be seen which is surrounded by a casing or a particle shell 30. The nanoparticle 10 therefore has a core/shell structure.

The material K of the particle core 20 is chemically more active than the material M of the particle shell 30. For example, the core material K is aluminum and the shell material M is aluminum oxide.

FIG. 2 shows a second exemplary embodiment of a nanoparticle 10. In contrast to the first exemplary embodiment, the nanoparticle is bar-shaped, not spherical. The internal set-up, however, is comparable. Thus, the nanoparticle 10 according to FIG. 2 also has a particle core 20 which is surrounded by a casing or a particle shell 30.

FIGS. 3 and 4 illustrate by way of example how the nanoparticles 10 can be produced.

First, microparticles MP are formed, in that initial material 70 for producing the particle core 20 of the nanoparticles 10 is comminuted, for example shredded in a shredder 80. The microparticles MP consist, for example, of aluminum.

The microparticles MP are subsequently processed further into particle cores 20 for the nanoparticles 10. For this purpose, the microparticles MP are stored in a container 100 and are conducted from there to a nanoparticle production apparatus 110. In this, nanoparticles are produced which form the aluminum particle cores 20 according to FIG. 1 or 2 (cf. FIG. 4).

The production of the particle cores 20 based on microparticles MP may take place, for example, within the framework of an atomization step, in which the microparticles MP are split into their atoms, and the split atoms are recomposed so as to form the particle cores 20. The atomization of the microparticles MP may take place, by flame spraying based on acetylene or by the action of a plasma. Such a plasma may be formed, for example, by a direct current arc, an alternating current arc or a pulsed arc.

FIG. 5 illustrates a further exemplary embodiment of the production of the particle cores 20. Initial material 200 can be seen which is located in a container 210 and passes from this to a plasma burner 220 which heats the initial material 200 to a temperature of above 10000° C. As a result of this heating, the initial material 200 is vaporized, so that material clusters in a nanoformat, referred to below as nanoclusters, are formed. The nanoclusters form the particle cores 20 for the further production of the nanoparticles 10 with a core/shell structure according to FIGS. 1 and 2.

The functioning of the plasma burner 220, as described in simplified form, is based on the fact that this, due to the high temperature of a plasma, decomposes the initial material 200 into its atoms and subsequently, within the framework of a condensing or of a condensation operation, condenses the atoms back into nanoparticles or nanoclusters which can be used further as particle cores 20 for the further production of the nanoparticles 10 with a core/shell structure according to FIGS. 1 and 2.

The particle cores 20 are subsequently coated with the particle shell 30; for example, an oxide layer may be formed by oxidation in an oxygen-containing gas. Alternatively, the particle cores may also be coated with a glass layer or ceramic layer; a glass layer may be applied, for example, using an SOG (spin-on glass) liquid which is subsequently cured so as to form the glass layer.

By means of the nanoparticles 10 produced in this way, functional layers can subsequently be formed, as will be shown by way of example with reference to FIGS. 6-9:

In FIG. 6 can be seen an exemplary embodiment of a functional element in the form of a turbine blade 300; for the sake of clarity, however, only a portion of the turbine blade 300 is illustrated. The turbine blade material contains, for example, cobalt nickel (CoNi) with a composition of approximately 50%:50%. The cobalt nickel fraction of the turbine blade material may amount, for example, to approximately 90%.

A functional layer 310 in the form of a protective coating is applied to the turbine blade 300. The functional layer 310 consists, for example, of MCrAlY material 320 with nanoparticles 10 contained in it. The nanoparticles have a core/shell structure, as was shown by way of example in FIGS. 1 and 2. The core material consists, for example, of aluminum, magnesium, iron, zinc or a mixture of these materials; an aluminum core, for example, is assumed below.

A thermal protection layer 330 is located on the functional layer 310 and is formed, for example, by a zirconium oxide ceramic layer of columnar structure.

The materials of the nanoparticles 10 are selected in such a way that the core material K of the particle cores 20 can diffuse through the particle shell 30. Aluminum thus passes into the MCrAlY material 320 at an outflow rate corresponding to the diffusion rate.

Oxygen, which passes, for example diffuses, through the thermal protection layer 330 into the MCrAlY material 320 on account of the high operating temperature during the operation of the turbine blade 300, is chemically bound by the aluminum atoms from the particle core 20, so that the latter is no longer available for corroding the MCrAlY material 320. In order to bring about such a protective action by the core material, the core material selected is preferably chemically more base and therefore more corrosive than the material of the MCrAlY material 320. As already mentioned, for example, nanoparticles with a core material consisting of aluminum are suitable for MCrAlY material.

In order to ensure that the shell material does not likewise corrode, and that the aluminum can subsequently react, unimpeded, with foreign substances within the functional layer material, the shell material is nobler than the core material; what is thus achieved is that, first, the core material corrodes and the shell material remains unaffected. What may be considered as shell material is, for example, a nobler metal, oxide, glass or enamel.

If more oxygen penetrates into the MCrAlY material 320 than can be bound by the core material diffusing out, the situation could occur where, for the lack of available core material, the shell material nevertheless corrodes and the protective action of the shell material is lost. This can be prevented very simply in that the selected shell material is nobler than the functional layer material; in this case, the functional layer material will corrode before the shell material, and the nanoparticles remain intact. The latter choice of material is recommended particularly when the shell material used is a metal which tends to corrode.

In FIG. 7 can be seen a further exemplary embodiment of a functional element in the form of a turbine blade 300.

In contrast to the exemplary embodiment according to FIG. 6, the functional layer 400 contains turbine blade material 410 into which the nanoparticles 10 are integrated.

Lotated on the functional layer 400 is a thermal protection layer 430 which is formed, for example, by a zirconium oxide ceramic layer of columnar structure.

The core material K of the nanoparticles 10 is preferably once again selected in such a way that it is both baser than the shell material and baser than the turbine blade material 410; it can therefore bind oxygen which passes into the turbine blade material 410 and can protect the turbine blade material. The core material consists, for example, of aluminum, magnesium, iron, zinc or a mixture of these materials. The shell material is preferably nobler than the turbine blade material 410; this prevents the shell material from being dissolved prematurely, for example due to corrosion.

In FIG. 8 can be seen a third exemplary embodiment of a functional element in the form of a turbine blade 300.

In contrast to the exemplary embodiment according to FIG. 7, a further layer 500 is located on the functional layer 400 which is formed by the turbine blade material 410 and the nanoparticles 10 (for example, with an Al/Al₂O₃ core/shell structure) which are contained in it. This further layer 500 consists, for example, of MCrAlY material and lies beneath a thermal protection layer 510 which may be formed by a zirconium oxide ceramic layer of columnar structure.

Due to the absence of nanoparticles, the further layer 500 has “baser” action than the functional layer 400, and it therefore serves as a sacrificial layer. This means that, first, the further layer 500 will corrode, and consequently the functional layer 400 is protected. Only when the further layer 500 is consumed or else damaged will a corrosion of the functional layer 400 lying beneath it occur. However, the corrosion of the functional layer 400 is then still delayed or braked by the nanoparticles 10, and therefore a very long useful life of the functional layer 400 is achieved.

A fourth exemplary embodiment of a turbine blade 300 can be seen in FIG. 9.

In contrast to the exemplary embodiment according to FIG. 8, a further functional layer 600 is located on the functional layer 400 which is formed by the turbine blade material 410 and the nanoparticles 10 contained in it. This further functional layer 600 consists, for example, of MCrAlY material 610 with nanoparticles 10 which, for example, may have an Al/Al₂O₃ core/shell structure.

The function of the further functional layer 600 is to protect the functional layer 400 lying beneath it. Only when the further functional layer 600 is consumed or else damaged will a corrosion of the functional layer 400 lying beneath it occur.

The further functional layer 600 may once again have located on it a thermal protection layer which is identified in FIG. 9 by the reference symbol 620 and which is formed, for example, by a zirconium oxide ceramic layer of columnar structure.

1. A method for producing a particle-containing functional layer, characterized in that the method comprising the steps of: introducing particles which have a particle core and a particle shell surrounding the particle core into the functional layer material,
wherein the material of the particle core being chemically more active than that of the particle shell, and
wherein the material of the particle shell making it possible for the material of the particle core to diffuse out through the particle shell into the functional layer material.

2. The method according to claim 1, wherein nanoparticles are introduced into the functional layer material.

3. The method according to claim 1, wherein the material of the particle core is more base or less inert than that of the particle shell.

4. The method according to claim 1, wherein the material of the particle core is more reactive with oxygen than that of the particle shell.

5. The method according to claim 1, wherein the material of the particle core is chemically more active than the functional layer material.

6. The method according to claim 1, wherein the material of the particle shell is chemically less active than the functional layer material or is exactly as active as the functional layer.

7. The method according to claim 1, wherein nanoparticles are used, the core material of which consists of aluminum, magnesium, iron, zinc or a mixture of these materials.

8. The method according to claim 1, wherein nanoparticles are used, the shell material of which consists of a nobler metal or metal mixture than the core material.

9. The method according to claim 1, wherein nanoparticles are used, the shell material of which consists of a metal oxide or aluminum oxide.

10. The method according to claim 1, wherein nanoparticles are used, the shell material of which consists of a glass or enamel.

11. The method according to claim 1, wherein the functional layer material contains MCrAlY material or is formed by it.

12. A functional element comprising a particle-containing functional layer, wherein the functional layer material contains particles which have a particle core and a particle shell surrounding the particle core,
the material of the particle core being more active than that of the particle shell, and
the material of the particle shell making it possible for the material of the particle core to diffuse out through the particle shell into the functional layer material.

13. The functional element according to claim 12, wherein the particles are nanoparticles.

14. The functional element according to claim 12, wherein the material of the particle core is more base or less inert than that of the particle shell.

15. The functional element according to claim 12, wherein the material of the particle core is more reactive with oxygen than that of the particle shell.

16. The functional element according to claim 12, wherein the functional element is formed by a turbine element or a turbine blade.

17. The functional element according to claim 12, wherein the material of the particle core is more base or less inert than the functional layer material.

18. The functional element according to claim 12, wherein the material of the particle shell is at least as noble or as inert as the functional layer material.

19. The functional element according to claim 12, wherein the core material consists of aluminum, magnesium, iron, zinc or a mixture of these materials.

20. The functional element according to claim 12, wherein the shell material consists of a nobler metal or metal mixture than the core material.

21. The functional element according to claim 12, wherein the shell material consists of a metal oxide or aluminum oxide.

22. The functional element according to claim 12, wherein the shell material consists of a glass or enamel.

23. The functional element according to claim 12, wherein the functional layer material contains MCrAlY material or is formed by it.

24. The functional element according to claim 12, wherein the functional layer material has material of the functional element or is formed by it.

25. The functional element according to claim 12, wherein the functional layer has applied to it a further layer, the latter containing MCrAlY material or being formed by it.

26. The functional element according to claim 25, wherein the further layer likewise has nanoparticles and forms a further functional layer.

27. The functional element according to claim 25, wherein a thermal protection layer is applied to the further layer or to the further functional layer.

28. A nanoparticle for the production of functional layers for functional elements wherein the nanoparticles have a particle core and a particle shell surrounding the particle core,
the material of the particle core being more active than that of the particle shell, and
the material of the particle shell making it possible for material of the particle core to diffuse out through the particle shell and out of the respective nanoparticle.

29. The nanoparticle according to claim 28, wherein the material of the particle core is more base or less inert than that of the particle shell.

30. The nanoparticle according to claim 28, wherein the material of the particle core is more reactive with oxygen than that of the particle shell.

31. A method for producing a nanoparticle, comprising the steps of forming a particle core and surrounding the particle core with a particle shell, wherein a less active material being selected for the particle shell than for the particle core, which material makes it possible for material of the particle core to diffuse out through the particle shell and out of the nanoparticle.
